(19) United States
(12) Patent Application Publication
(10) Pub. No.: US 2016/0144647 A1
(43) Pub. Date: May 26, 2016

(54) Oliophilic Coating On Underside Of Printing Plate

(71) Applicant: ANOCOIL CORPORATION, Rockville, CT (US)

(72) Inventor: Howard A. Fromson, Stonington, CT (US)

(73) Assignee: ANOCOIL CORPORATION, Rockville, CT (US)

(21) Appl. No.: 14/551,166

(22) Filed: Nov. 24, 2014

(51) Int. Cl. B41N 1/12; C25D 11/16; C25D 11/18; C25D 7/00

(52) U.S. Cl. CPC B41N 1/12; C25D 7/00; C25D 11/16; C25D 11/18

(57) ABSTRACT

In a stack of lithographic printing plate precursors, each plate has an aluminum substrate, a photo-polymerizable (PS) layer carried on the upper surface of the substrate, a water soluble topcoat oxidation inhibitor carried on the PS layer, and a water insoluble bottom coat on the lower surface of the substrate, wherein the bottom coat of each intermediate plate is in direct covering contact with the topcoat of an immediately adjacent plate. The associated process includes cutting through multiple sections of the finished web without interleaving to produce stacks of finally sized precursor plates, and without interleafing, packaging together at least 25 stacked and confronting precursor plates.

### BACKGROUND

The present application relates to photosensitive plates used for lithographic printing, and particularly to negative working, photopolymerizable plates. Messrs.

Plates of this type commonly consist of a grained and anodized aluminum substrate, a solvent soluble, imageable photosensitive layer (PS layer) carried on the substrate, and a water soluble, oxygen barrier topcoat. The top coat prevents oxygen in the air from interacting with the PS layer in a way that reduces the cross linking potential of the PS material.

The manufacturer of such plates (sometimes referred to precursor plates) typically ships the plates to printing plants in sealed packages of 25-50 plates each. Both prior and during shipping, and typically after receipt of shipment, these packages or boxes are further stacked, with up to ten packages in each stack. Thus, the lower-most plates in the bottom stack of packages can be subjected to the weight of nearly 500 plates. Furthermore, as packages are moved they can induce sheer forces within a given package and between packages, thereby subjecting the plates to scratching or other scarring.

The prevailing technique for minimizing potential damage between plates is to provide a paper or similar interleaf between the top of one plate and the bottom of the next higher plate. The interleaf can serve another function when applied to sections of fully coated and dried web coming off the coating line, by facilitating the simultaneous cutting of individual plates from a stack of such sections of webs that have emerged from the coating line, to minimize friction between the cutting tool and the plates.

Several techniques are known for avoiding the use of interleafs, as described, for example in U.S. Pat. No. 5,496,677. These range from applying a peelable protective layer on the PS layer or on the back face of the substrate during manufacture of the web, which avoids the step of adding interleafing between cut plates, but still requires the removal of the protective layer at the print mill. Other, both peelable and non-peelable protective layers are described for the PS layer or the back face of the substrate. However, these are concerned with one or both of providing lubrication for cutting plates from the original web, and avoiding scratches as plates move relative to each other during handling or stacking.

### SUMMARY

None of these techniques, however, is derived from recognition of the potential picking reaction between the confronting surfaces in a stack of plates.

Accordingly, the present inventor realized that if interleafing were to be eliminated for stacking plates whereby a water soluble topcoat confronts an anodized aluminum substrate under the pressure of the stack, the entire hydrophilic substrate surface would be in blanket contact with the entire hydrophilic topcoat. The contact between two hydrophilic surfaces results in a picking reaction at the topcoat, with random, localized removal of topcoat material. Such localized removal of the topcoat permits random penetration of oxygen into the PS layer in areas where image will be desired. The picked areas experience less polymerization and exhibit wear earlier than the rest of the plate. On press, ink will not adhere to the exposed hydrophilic areas beneath the picked PS material. The resulting printed media will show random holes in the image areas.

According to the solution, in a stack of lithographic printing plate precursors, each plate has an aluminum substrate, a photopolymerizable PS layer carried on the upper surface of the substrate, a water soluble topcoat oxidation inhibitor carried on the PS layer, and a water insoluble bottom coat on the lower surface of the substrate, wherein the bottom coat of each intermediate plate is in direct covering contact with the topcoat of an immediately adjacent plate.

The stack can have 25-50 plates contained in a package such as a box or bag. Ten or more packages can be stacked during handling or storage by the manufacturer, shipper, and end user.

Preferably, an oliophilic material is applied to one face of a raw aluminum web before the PS layer and topcoat are applied to the other face of the web. This pretreatment can be performed by the supplier of coiled aluminum sheet (web) before delivery to the plate manufacturer or ay a pretreatment station in the plate manufacturer's plant.

As used herein, “coat” includes all techniques for producing a filmic layer of one material on another, including lamination. Preferably, the bottom coat is laminated on the web before the PS layer and top coat are applied. Most preferably, the bottom coat is an electrically non-conductive oliophilic laminate.

When the aluminum web is pretreated with a nonconductive bottom coat, the graining and anodizing steps can be limited to only the upper surface for receiving the PS layer. None of the electrical fields or electrochemical reactions take place on the bottom surface of the aluminum. This not only saves a tremendous amount of energy, but also assures that no graining or anodizing occurs at the bottom margins of the web, which would otherwise require trimming.

A process embodiment for manufacturing lithographic printing plate precursors, comprises the steps of (a) selecting a coil consisting essentially of an aluminum sheet with an electrically nonconductive, oliophilic polymer material coated on one side of the sheet; (b) graining and anodizing only the other side of the sheet to form a substrate web with a grained and anodized top surface and a polymeric, oliophilic bottom surface; (c) in a coating line, applying a photopolymerizable resin layer to the top surface of the web; (d) in a coating line, applying a water soluble oxygen inhibition layer to the resin layer to produce a finished web; (e) without interleafing, cutting through multiple sections of the finished web to produce stacks of finally sized precursor plates; and (f) without interleafing, packaging together at least 25 stacked and confronting precursor plates.

### BRIEF DESCRIPTION OF THE DRAWING

Aspects of the invention are disclosed in greater detail below with reference to the accompanying drawing, in which:

FIG. 1 shows a plate precursor in cross section according to an aspect of the invention;

FIG. 2 shows the substrate for the plate precursor of FIG. 1, with grained and anodized upper surface and an electrically non-conductive water-insoluble bottom coat;

FIG. 3 schematically shows a stack of three precursors of the type shown in FIG. 1, without any interleafing;

FIG. 4 schematically shows a stack of precursors contained in a box;

FIG. 5 schematically shows a stack of the boxes shown in FIG. 4; and

FIGS. 6A and B schematically represent a process for producing packaged precursor plates according to an aspect of the invention.

### DETAILED DESCRIPTION

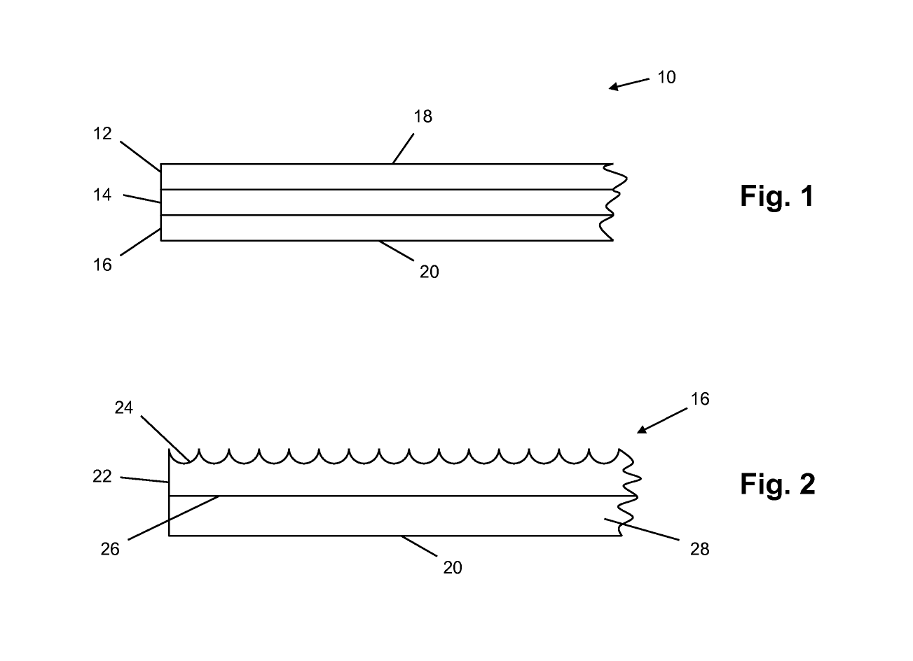

As represented In FIG. 1, plate precursor 10 has a topcoat 12 of a water soluble oxidation inhibitor, such as polyvinyl alcohol, a photopolymerizable (PS) layer 14 that is imageable with any of violet, ultraviolet, or infra-red lasers, and a metal substrate 16, preferably aluminum. The plate 10 has a hydrophilic top surface 18 defined by the top coat 12 and a water insoluble bottom surface 20 of the substrate 16.

FIG. 2 shows that the substrate 16 consists essentially of an aluminum sheet 22 with a grained and anodized upper surface 24 and a lower surface 26 bonded or otherwise adhered such as by lamination, to film 28 of a preferably electrically conductive polymer material. To reduce the relatively higher material cost of aluminum sheet, the laminate 28 can contribute 25-75% to the overall thickness of the substrate 16.

Preferably, the aluminum sheet 22 is pretreated with bottom coat 28 and the composite thereafter subjected to a process for graining and anodizing only the upper surface 24 of the aluminum sheet 22. As a result, the upper surface 24 is hydrophilic and the bottom surface 20 is oliophilic.

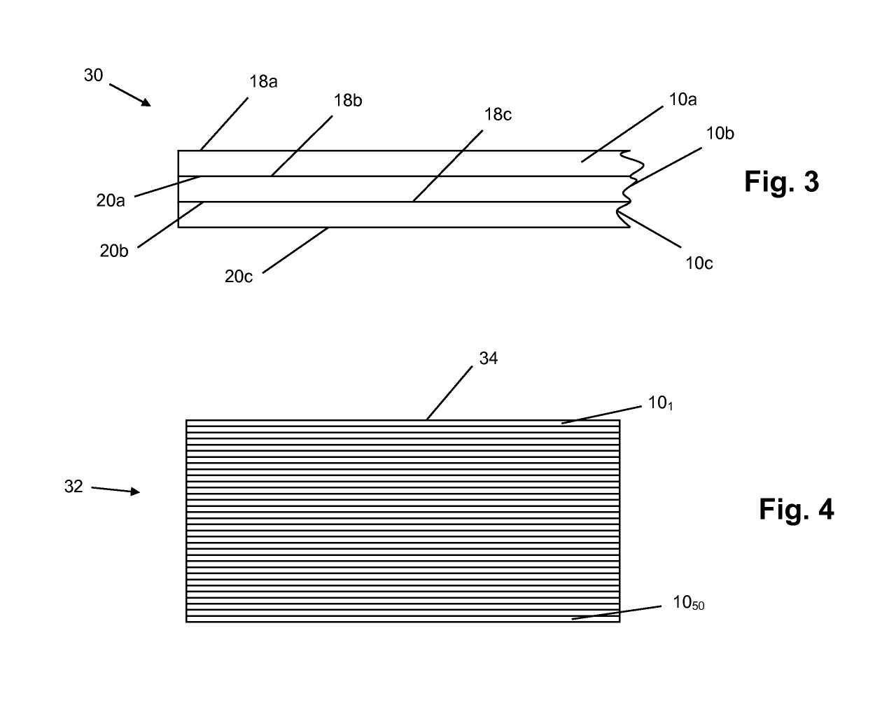

FIG. 3 shows a stack 30 of three precursors 10a, 10b, and 10c with respective top surfaces 18a, 18b, and 18c and respective bottom surfaces 20a, 20b, and 20c. Hydrophilic surface 18b confronts oliophilic surface 20a and hydrophilic surface 18c confronts oliophilic surface 20b. Due to the dissimilar solubility, and particularly the difference in hydrophilicity, no dissolution reaction or mutual affinity reaction (i.e., no chemical reaction or inter-molecular penetration) can occur anywhere between the confronting surfaces. This avoids localized “picking” of top coat material.

FIG. 4 shows a combination 32 of a multiplicity 10₁, 10₂ . . . 10₅₀ of up to 50 or more precursor plates stacked within a package 34, with respective confronting surfaces as shown in FIG. 3.

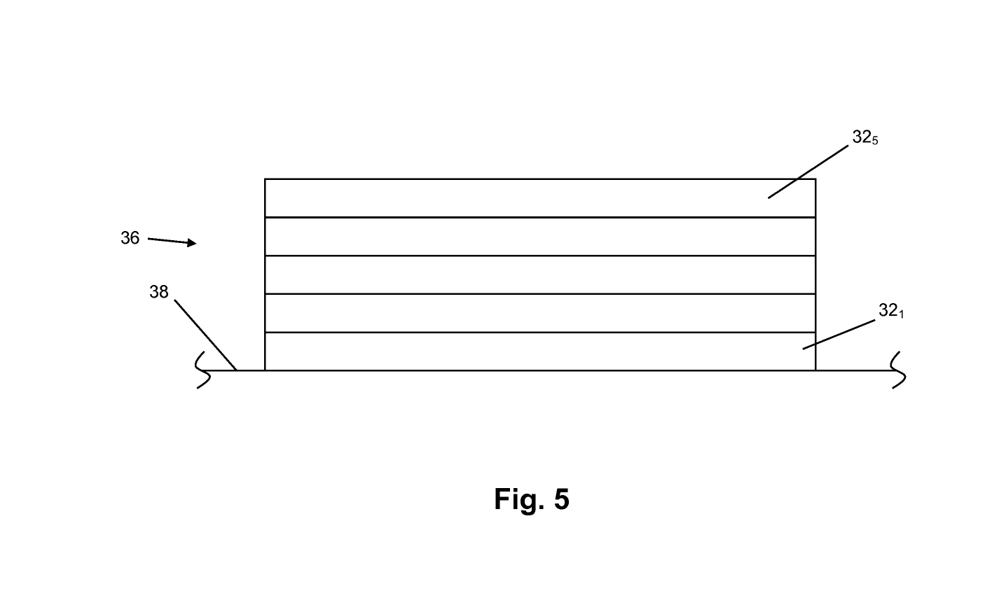

FIG. 5 shows a stack 36 of five or more packages 32₁ . . . 32₅ on a floor or pallet 38 in the manufacturing plant, truck bed, or print mill storage room.

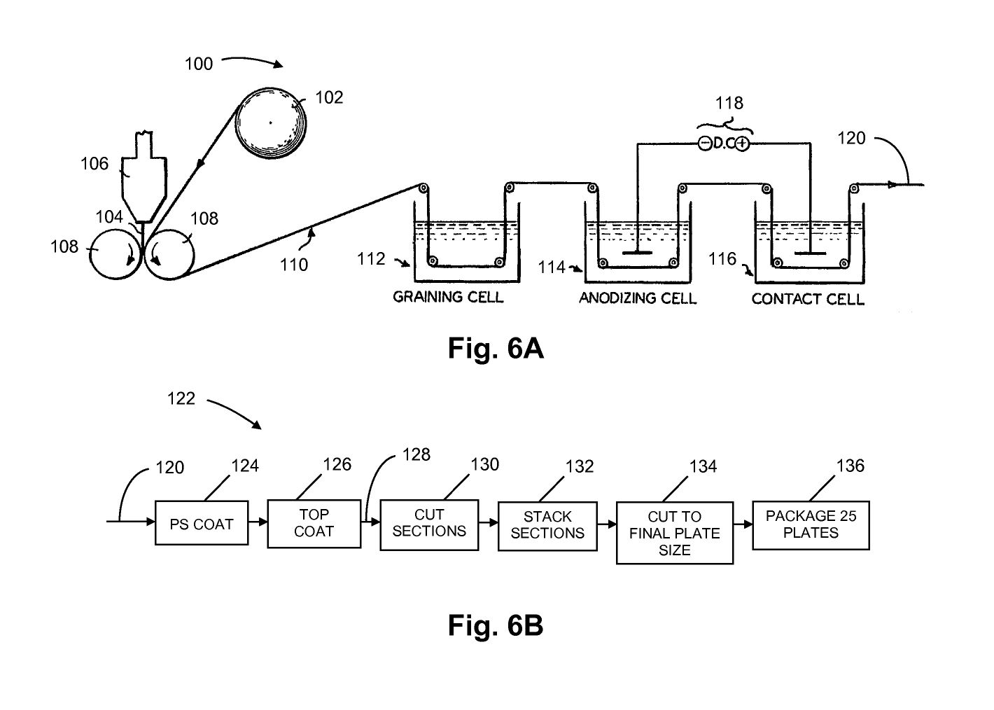

FIGS. 6A and B show a plate manufacturing line 100 for producing the stacked precursor plates. A bulk coil of aluminum sheet 102 having a nominal width and a nominal thickness is coated on one side with an electrically non-conductive, oliophilic material 104, preferably polymeric. This coating is shown as applied with an extruder 106 with associated rollers 108, but any technique for applying a filmic layer is suitable. This produces a composite sheet 110 that is conveyed to a graining cell 112 and liquid contact anodizing cells 114 and 116. The preferred direct current 118 process is described with respect to FIGS. 1a and 1b in U.S. Pat. No. 4,065,364, the disclosure of which is hereby incorporated by reference, but the liquid cell anodizing can also be performed with an alternating current source, at half the energy efficiency.

As represented by item 16 in FIG. 2, this web 120 consists essentially of an aluminum sheet with an electrically nonconductive, oliophilic polymer material laminated on one side of the sheet, grained and anodized on only the other side of the sheet to form a substrate web. Because one side (i.e., bottom) of the discharged web 120 was rendered electrically non-conductive before graining and anodizing, the bottom surface does not exhibit any graining or anodizing incidental to the graining and anodizing of the other (top) surface. Therefore no trimming of the web 120 to remove grained and anodized surfaces at the bottom near the edges is required. The aluminum sheet 102 can have a nominal width dimension that is the same as one of the length or width dimensions of the finally sized precursor plates.

The discharged web 120 can be coiled for delivery to a PS coating line or conveyed directly to the PS coating line 122 represented in FIG. 6B. The subsequent steps include 124 applying and drying a photopolymerizable resin layer to the top surface of the substrate web, then applying 126 and drying a water soluble oxygen inhibition layer as a top coat to the resin layer to form a fully coated, final web 128. The constituents of the fully coated web 128 are shown as item 10 in FIG. 1.

It should be appreciated that the finally sized precursor plates are rectangular, with consistent length and width dimensions. As the final web 128 is continuously discharged, it is cut 130 into a multiplicity of that have the same width as the web but of a convenient length corresponding to a multiple of one of length or width dimensions of the precursor plates. Without interleafing, the multiplicity of sections are placed 132 one on top the other whereby the top coat of one section directly confronts the polymer laminate of a next higher section (as represented in FIG. 3). In a further step 134 without interleafing, cuts are made entirely through the multiplicity of sections to produce a plurality of stacks of finally sized precursor plates. One or more stacks of the cut-to-size plates are packaged together 136 as a shippable group of 25-50 plates, as represented by 32 in FIG. 4. Such packages can be further stacked as represented by 36 in FIG. 5.

1. A stack of lithographic printing plate precursors comprising:
a multiplicity of said plates, including a top plate, a bottom plate and a plurality of intermediate plates, wherein each plate comprises
an aluminum sheet with upper and lower surfaces;
a photopolymerizable layer carried directly or indirectly on the upper surface of the sheet;
a water-soluble top coat oxidation inhibitor carried directly or indirectly on the photopolymerizable layer; and
a water-insoluble bottom coat on the lower surface of the aluminum sheet;
wherein the bottom coat of each intermediate plate is in direct covering contact with the top coat of an immediately adjacent plate.

2. The stack of plates according to claim 1, wherein the stack of plates is contained in a sealed package.

3. The stack of plates according to claim 1, wherein said stack includes at least 25 plates.

4. The stack of plates according to claim 2, wherein said stack contains at least 25 plates.

5. The stack of plates according to claim 4, wherein a plurality of said packages are stacked on a floor or pallet.

6. The stack of plates according to claim 1, wherein said bottom coat is oliophilic.

7. The stack of plates according to claim 6, wherein said bottom coat is laminated to the lower surface of the sheet.

8. The stack of plates according to claim 6, wherein the bottom coat is electrically non-conductive.

9. The stack of plates according to claim 8, wherein the entire upper surface of the sheet is grained and anodized and none of the lower surface of the sheet is grained or anodized.

10. The stack of plates according to claim 1, wherein
the top coat is polyvinyl alcohol;
the bottom coat is an electrically non-conductive and oliophilic polymer laminated to the lower surface of the sheet; and
said stack consists of at least 25 plates contained in a sealed package.

11. The stack of claim 1, wherein the aluminum sheet and bottom coat form a substrate and the bottom coating has a thickness in the range of 25%-75% of the thickness of the substrate.

12. A method for manufacturing lithographic printing plate precursors, comprising the step sequence of:
a. selecting a source consisting essentially of an aluminum sheet with an electrically nonconductive, oliophilic polymer material laminated on one side of the sheet;
b. graining and anodizing only the other side of the sheet to form a substrate web with a grained and anodized top surface and a polymeric, oliophilic bottom surface;
c. applying and drying a photopolymerizable resin layer to the top surface of the substrate web;
d. applying and drying a water soluble oxygen inhibition layer as a top coat to the resin layer to form a fully coated, a final web;
e. cutting the final web into a multiplicity of sections;
f. without interleafing, placing the multiplicity of sections one on top the other whereby the top coat of one section directly confronts the polymer laminate of a next higher section; and
g. without interleafing, cutting entirely through the multiplicity of sections to produce a plurality of stacks of finally sized precursor plates.

13. The method of claim 12, including the further step of packaging together at least 25 stacked and confronting precursor plates.

14. The method of claim 12, wherein the step of anodizing is performed with a liquid contact cell.

15. The method of claim 12, wherein the finally sized precursor plates are rectangular with the same length and width dimensions from plate to, and in step g, the cut sections are rectangular with said precursor plate length and width dimensions.

16. The method of claim 12, wherein the substrate web is continuously conveyed through steps c. and d. and step e. comprises cutting sections off the final web as the final web is continuously discharged from drying in step d.

17. The method of claim 14, wherein
the finally sized precursor plates are rectangular with the same length and width dimensions from plate to plate;
the aluminum sheet has a width dimension that is the same as one of said length or width dimensions of the finally sized precursor plates; and
in step g, the cut sections are rectangular with said precursor plate length and width dimensions.
